(19) United States
(12) Patent Application Publication
(10) Pub. No.: US 2010/0233503 A1
(43) Pub. Date: Sep. 16, 2010

(54) PANEL FOR A STORAGE CONTAINER

(76) Inventors: Joseph M. Zachman, Lafayette, IN (US); Brett Allan Brooks, West Lafayette, IN (US); Patrick M. Griffin, Lafayette, IN (US); Brian L. Yeagy, Lafayette, IN (US); David Pickup, Lafayette, IN (US); Dwaine D. Speer, West Lafayette, IN (US); David P. Kunkel, Lebanon, IN (US)

Correspondence Address: BARNES & THORNBURG LLP, 11 SOUTH MERIDIAN, INDIANAPOLIS, IN, 46204, US

(21) Appl. No.: 12/721,027

(22) Filed: Mar. 10, 2010

Related U.S. Application Data
(60) Provisional application No. 61/160,127, filed on Mar. 13, 2009.

(51) Int. Cl. B32B 3/12; B32B 3/28; B32B 15/01

(52) U.S. Cl. 428/593; 428/178

(57) ABSTRACT

A panel for a storage container, such as a trailer, for example, includes a first, generally planar layer and a second layer coupled to the first layer. The second layer is configured to define a plurality of channels therein.

This application claims priority under 35 U.S.C. §119(e) to U.S. Provisional Application Ser. No. 61/160,127 filed Mar. 13, 2009 entitled PANEL FOR A STORAGE CONTAINER, the entirety of which is incorporated by reference herein.

### FIELD OF THE INVENTION

The present disclosure is related to a panel for a van-type trailer or other storage container and particularly to a panel having multiple layers coupled to each other.

### BACKGROUND

Van-type trailers and other storage containers, such as dry freight, reefer, truck bodies, portable or fixed storage units, for example, include any number of panels for use as interior side liners, sidewalls, doors, the roof and/or nose of the storage containers. Such panels may include metal panels, composite panels, plywood panels, and/or plastic liners, for example.

### SUMMARY

The present invention may comprise one or more of the features recited in the attached claims, and/or one or more of the following features and combinations thereof.

According to one aspect of the present disclosure, a panel for a storage container includes a first, generally planar layer and a second layer coupled to the first layer. The second layer is configured to define a plurality of channels therein.

In one illustrative embodiment, the plurality of channels may include a plurality of inner channels between the first layer and the second layer and a plurality of outer channels.

In another illustrative embodiment, the cross-sectional shape of the channels may be generally semi-circular, rectangular, triangular, and/or trapezoidal. In another illustrative embodiment, the channels may be interlocking and/or overlapping embossments. Further, such channels may include cross-shaped embossments.

In still another illustrative embodiment, the first and second layers may be made from metal.

In another illustrative embodiment, the channels of the second layer may be configured to extend along a width of the panel.

Illustratively, the first and second layers may be coupled to each other by an adhesive, friction welding, and/or resistance welding.

In yet another illustrative embodiment, the panel may also include a third, generally planar layer coupled to the second layer and spaced-apart from the first layer.

In still another illustrative embodiment, the first layer may be made of a first material and the second layer may be made of a second material different from the first material. Illustratively, the first material may be steel and the second material may be aluminum.

According to another aspect of the present disclosure, a panel for a storage container includes a first, generally planar layer and a second layer coupled to the first layer. The second layer is configured to define a first, flat portion adjacent and coupled to the first layer, and a plurality of second portions spaced-apart from the first layer.

In one illustrative embodiment, the second portions may be configured to define an enclosed void between the first layer and the second layer. Illustratively, the void may be cross-shaped.

In another illustrative embodiment, the first portions may be generally planar. Further illustratively, a cross-sectional shape of the second portions may be generally semi-circular, rectangular, triangular, and/or trapezoidal.

In yet another illustrative embodiment, the panel may be a sidewall panel or a roof panel of the storage container.

In still another illustrative embodiment, the panel may also include a third, generally planar layer coupled to the plurality of second portions of the second layer.

In another illustrative embodiment, the first layer may be an outer layer of the storage container and the second layer may be an inner layer of the storage container.

Accordingly to still another aspect of the present disclosure, a sidewall panel for a storage container includes an outer, generally planar metal sheet and an inner metal sheet coupled to the outer sheet. The sidewall panel includes a plurality of channels formed between the inner sheet and the outer sheet. Illustratively, the plurality of channels are configured to extend along a width of the panel to define a longitudinal axis parallel to a length of the storage container.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a panel showing an inner layer defining a plurality of spaced-apart channels and a generally flat outer layer coupled to the inner layer.

FIG. 2 is an enlarged partial perspective view of a portion of the panel of FIG. 1.

FIG. 3 is a sectional view taken along line 3-3 of FIG. 1.

FIG. 4 is a sectional view of another panel showing a generally flat outer layer and an inner layer coupled to the outer layer and defining a plurality of spaced-apart rectangular channels.

FIG. 5 is a sectional view of yet another panel showing a generally flat outer layer and an inner layer coupled to the outer layer and defining a plurality of spaced-apart triangular channels.

FIG. 6 is a sectional view of still another panel showing a generally flat outer layer and an inner layer coupled to the outer layer and defining a plurality of spaced-apart trapezoidal channels.

FIG. 7 is a sectional view of another panel showing first and second generally flat outer layers and an inner layer, or core, coupled to and positioned between the outer layers to define a plurality of spaced-apart rectangular channels.

FIG. 8 is a sectional view of yet another panel showing first and second generally flat outer layers and an inner layer, or core, coupled to and positioned between the outer layers to define a plurality of spaced-apart trapezoidal channels.

FIG. 9 is a perspective view of another panel showing a generally flat outer layer and an inner layer coupled to the outer layer and defining a plurality of spaced-apart cross shaped voids.

### DETAILED DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same. While the concepts of this disclosure are described in relation to a towable trailer, it will be understood that they are equally applicable to storage containers generally, and more specifically to transportable containers for transporting one or more objects, examples of which include, but should not be limited to, straight truck bodies, small personal and/or commercial trailers and the like.

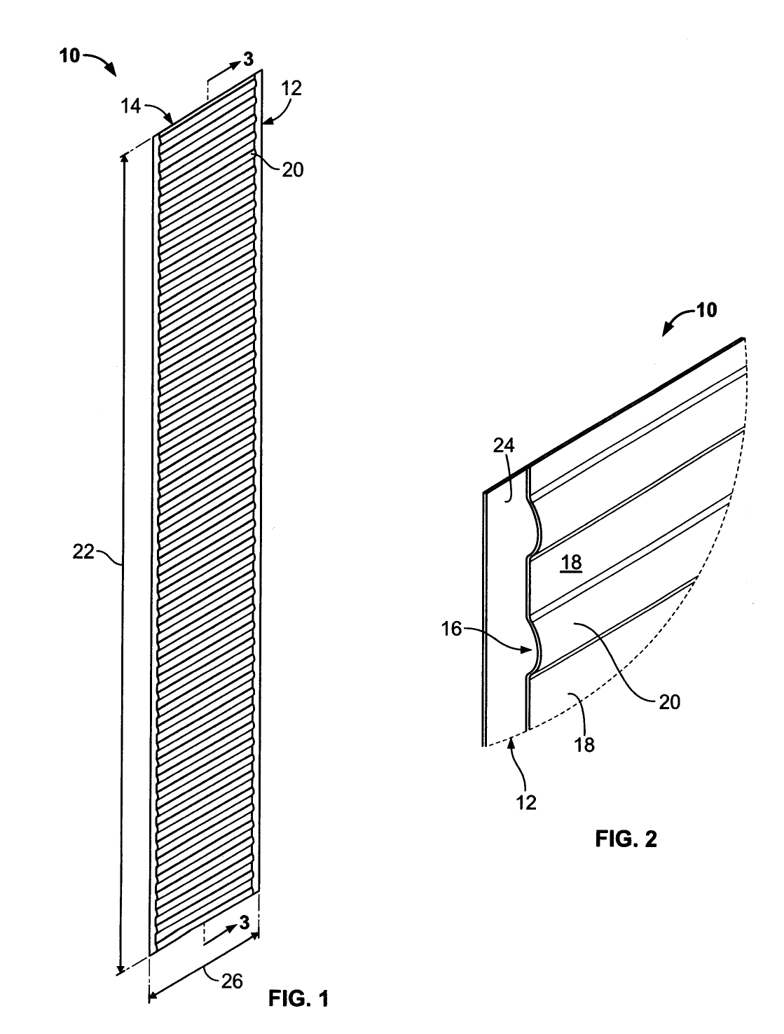

Referring now to FIG. 1, a panel 10 for use with a trailer or other storage container (not shown) includes a generally flat, or planar, outer layer 12 and an inner layer 14 coupled to the flat outer layer 12. The inner layer 14 is illustratively formed to include a plurality of channels 16. Each channel 16 is positioned to lie in spaced-apart relation to each adjacent channel 16 to define a repeating pattern of channels 16 of the inner layer 14.

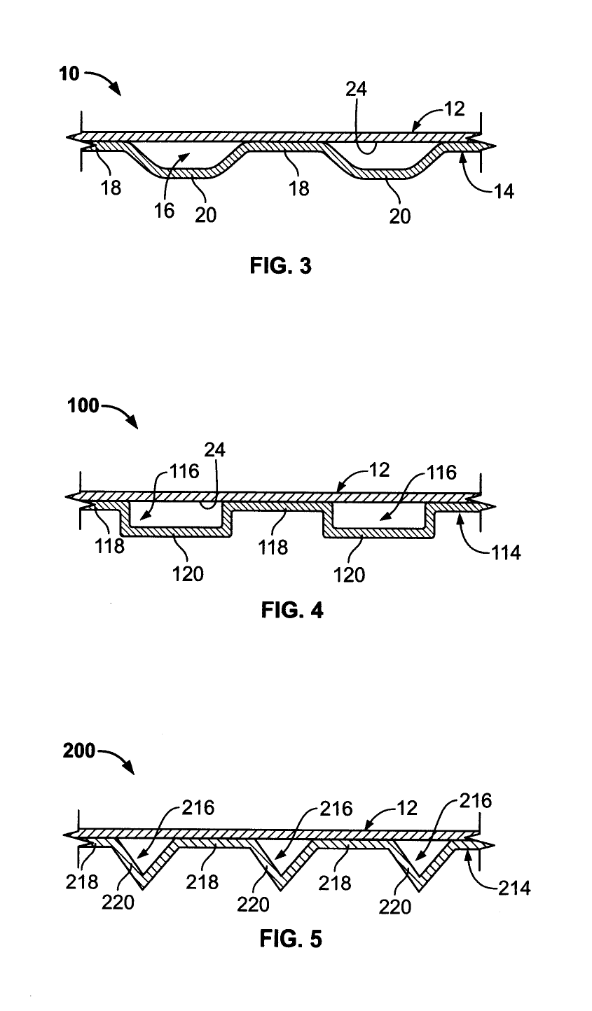

Illustratively, the outer layer 12 may be made of metal, such as steel, aluminum, or stainless steel, for example, as well as metal alloys or any other suitable material. Likewise, the inner layer 14 may similarly be made metal, such as steel, aluminum, or stainless steel, for example, as well as metal alloys or any other suitable material. As suggested in FIGS. 1 and 2, and shown in FIG. 3, the inner layer 14 is formed to include a plurality of semi-circular shaped channels 16 arranged to extend toward or face the outer layer 12. In particular, the inner layer 14 includes a plurality of spaced-apart first portions 18 and a plurality of spaced-apart second portions 20 such that the first and second portions 18, 20 are arranged to alternate along a length 22 of the panel 10. Illustratively, the first portions 18 are adjacent to and coupled to an inner surface 24 of the outer layer 12 while the second portions 20 are spaced-apart from the outer layer 12 to define the semi-circular channels 16. As such, the inner layer 14 of the panel 10 is generally corrugated. As shown in FIG. 1, the channels 16 extend horizontally across a width 26 of the panel 10. As such, in use as a sidewall panel of a storage container, for example, the channels 16 of the panel 10 would be configured to extend along a length of the storage container (i.e., from a front end of the storage container to a rear end of the storage container). In other words, the channels 16 would be oriented such that a longitudinal axis of each channel 16 would be generally parallel to the length of the storage container. However, it is understood that the panel 10 may include channels extending across the length 22 of the panel 10 as well as channels extending in any other direction, such as diagonally across the panel 10, for example.

As noted above, the outer layer 12 and the inner layer 14 are coupled to each other to form the panel 10. Illustratively, the outer layer 12 and the inner layer 14 may be bonded to each other using an adhesive (not shown) as well as other fasteners such as bolts, pins, screws, and rivets, for example. Further, the outer layer 12 and the inner layer 14 may be welded to each other using friction or resistance welding techniques, for example. In other words, the outer layer 12 and the inner layer 14 may be coupled to each other in any number of suitable ways using any number of suitable fastening devices or materials. Further illustratively, the outer layer 12 and the inner layer 14 may be extruded, rolled, punched, pressed or otherwise formed by any suitable means to create the generally flat outer layer 12 and the generally corrugated inner layer 14.

Looking now to FIG. 4, another panel 100 includes the generally flat outer layer 12 and an alternative inner layer 114. Illustratively, the inner layer 114 includes a plurality of alternating first and second portions 118, 120 to define a plurality of rectangular-shaped channels 116 therein. The first portions 118 are adjacent to and coupled to the inner surface 24 of the outer layer 12 while the second portions 120 include horizontal sections parallel to and spaced-apart from the first portions 118 and the outer layer 12 as well as vertical sections coupled to and extending between the horizontal sections and the first portions 118 to define the rectangular-shaped channels 116. Illustratively, each rectangular-shaped channel 116 is positioned to lie in spaced-apart relation to each adjacent channel 116.

Looking now to FIG. 5, another panel 200 includes the generally flat outer layer 12 and an alternative inner layer 214. Illustratively, the inner layer 214 includes a plurality of alternative first and second portions 218, 220 to define a plurality of triangular-shaped channels 216. The first portions 218 are adjacent to and coupled to an inner surface 24 of the outer layer 12 while the second portions 220 include first and second angled sections spaced-apart from the outer layer 12 and coupled to each other at one end and to the first portions 218 at the other end to define the triangular-shaped channels 216. Illustratively, each triangular-shaped channel 216 is positioned to lie in spaced-apart relation to the adjacent channel 216.

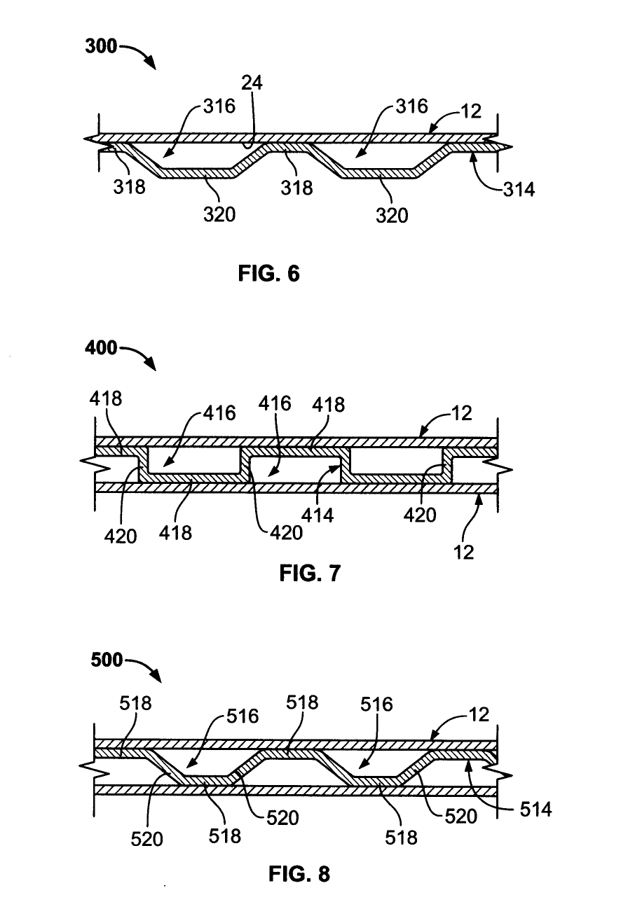

Looking now to FIG. 6, another panel 300 includes the generally flat outer layer 12 and an alternative inner layer 314. Illustratively, the inner layer 314 includes a plurality of alternative first and second portions 318, 320 to define a plurality of trapezoidal-shaped channels 316. The first portions 318 are adjacent to and coupled to an inner surface 24 of the outer layer 12 while the second portions 320 include horizontal sections parallel to and spaced-apart from the outer layer 12 as well as angled side sections extending between and coupled to the horizontal sections and the first portions 318 to define the trapezoidal-shaped channels 316. Illustratively, each trapezoidal-shaped channel 316 is positioned to lie in spaced-apart relation to the adjacent channel 316.

Illustratively, the inner layers 14, 114, 214, 314 of the aforementioned 10, 100, 200, 300 each include channels 16, 116, 216, 316 which generally face inwardly toward the respective outer layers 12 to form passageways open at the ends of each channel 16, 116, 216, 316, but which are otherwise enclosed. It should be noted, however, that the inner layers 14, 114, 214, 314 are further configured to define outer channels generally facing outwardly away from the outer layer 12 such that the inner layers 14, 114, 214, 314 each define alternating inner and outer channels of the respective panels 10, 100, 200, 300.

Looking now to FIG. 7, another panel 400 includes first and second generally flat, spaced-apart outer layers 12 and an inner, or core, layer 414 positioned between and coupled to each of the outer layers 12. Illustratively, the core layer 414 is the same as or similar to the inner layer 114 of the panel 100 shown in FIG. 4 such that the core layer 414 is formed to include a plurality of rectangular-shaped channels 416. Illustratively, the core layer 414 includes a plurality of alternating horizontal portions 418 generally parallel to the outer layer 12 and a plurality of alternating vertical portions 420 coupled to and positioned between the horizontal portions 418 to define the upper and lower rectangular-shaped channels 416. Illustratively, the horizontal portions 418 are each coupled to one of the first and second outer layers 12. Accordingly, a plurality of channels 416 are defined between the core layer 414 and each of the outer layers 12.

Looking now to FIG. 8, another panel 500 includes first and second generally flat, spaced-apart outer layers 12 and an inner, or core, layer 514 positioned between and coupled to each of the outer layers 12. Illustratively, the core layer 514 is the same as or similar to the inner layer 314 of the panel 100 shown in FIG. 6 such that the core layer 514 is formed to include a plurality of trapezoid-shaped channels 516. Illustratively, therefore, the core layer 514 includes the plurality of alternating horizontal portions 518 generally parallel to the outer layer 12 and a plurality of alternating angled portions 520 coupled to and positioned between the horizontal portions 518 to define the upper and lower trapezoid-shaped channels 516. Illustratively, the horizontal portions 518 are each coupled to one of the first and second outer layers 12. Accordingly, a plurality of channels 516 are defined between the core layer 520 and each of the outer layers 12.

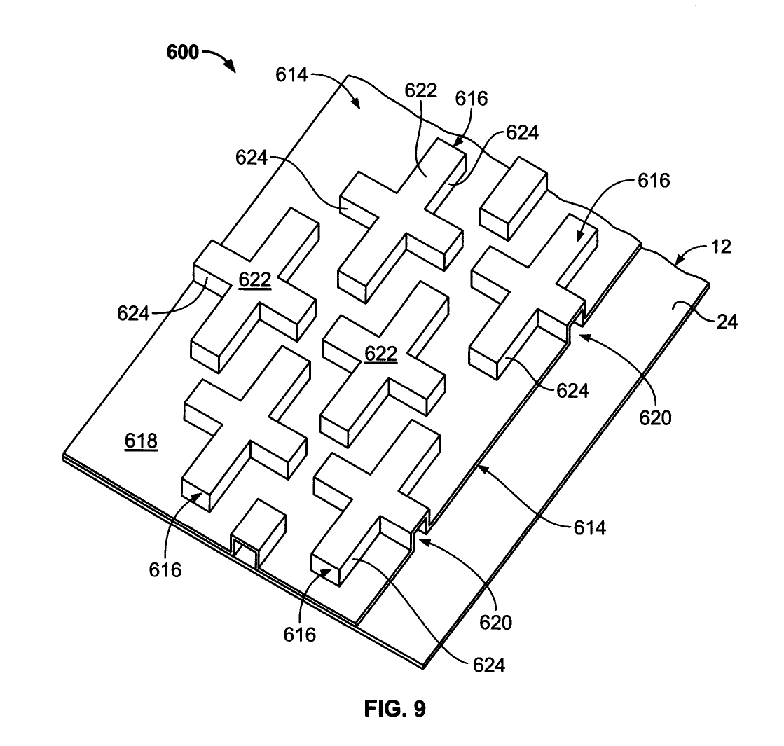

Looking now to FIG. 9, yet another panel 600 includes the generally flat outer layer 12 and an alternative inner layer 614. The inner layer 614 is formed to include a generally flat sheet portion 618 having a plurality of cross-shaped raised portions 616 formed therein. In other words, the inner layer 614 is embossed to define the cross-shaped raised portions 616. Each cross-shaped raised portion 616 includes a first section 622 spaced-apart from and parallel to the flat sheet portion 618 as well as a plurality of second sections or walls 624 coupled to and extending between the first section 622 and the sheet portion 618 of the inner layer 614. Illustratively, each cross-shaped raised portion 616 is positioned to lie in spaced-apart relation to each adjacent raised portion 616. Illustratively, the sheet portion 618 of the inner layer 614 is positioned adjacent to and coupled to the outer layer 12 such that each cross-shaped raised portion 616 generally faces the outer layer 12 to define an enclosed cross-shaped space or void 620 between the outer layer 12 and inner layer 614. While the panel 600 of the present disclosure includes generally cross-shaped embossments, it is within the scope of this disclosure to include a panel having embossments of any size and shape as well as any combination of sizes and shapes. Further, the embossments may or may not include interlocking and/or overlapping embossments. Further, the embossments may define enclosed or interconnected voids between the outer layer 12 and the inner layer 614 of the panel 600.

Illustratively, the panels 10, 100, 200, 300, 400, 500, 600 each include one or more outer layers and an inner layer, or core, coupled thereto. Further, each of the inner layers 14, 114, 214, 314, 414, 515, 614 is formed to define channels or voids having various shapes including semi-circle, triangle, rectangle, trapezoidal, and cross-shaped. However, it is within the scope of this disclosure for the panels disclosed herein to include an inner layer having channels or voids of any suitable shape or shapes formed therein. As such, the channels and voids of the inner layers disclosed herein may be of any suitable size and shape as well as any combination of sizes and shapes.

Illustratively, the panels 10, 100, 200, 300, 400, 500, 600 disclosed herein may be used as a sidewall, a roof, a nose, a door, or an interior side liner bonded, welded, or otherwise fastened to the interior of a storage container, for example, for various types of storage containers including trailers such as a dry freight trailer, a reefer trailer, a refrigerator trailer, a truck body, as well as portable or fixed storage units, for example.

In use, the inner layers of the panels 10, 100, 200, 300, 400, 500, 600 operate to structurally reinforce the respective outer layers to which they are attached. In particular, the inner layers provide increased stiffness to the outer layers in one or more directions, and particularly in the direction parallel to the channels or voids formed therein. Further, while the inner layers operate to provide increased strength and stiffness to the panels, the inner layers also operate to reduce an overall weight of the panel by providing the channels or voids within the panels. As noted above, the inner and outer layers may be made from metals such as steel, aluminum, or stainless steel, for example, metal alloys, or other suitable materials. It should be appreciated that the inner and outer layers of a single panel may be made from different materials. For example, the inner layer may be made from aluminum while the outer layer(s) may be made from steel, or visa vera. It should also be understood that the inner and outer layers of the panels may be made from non-metallic materials.

While the invention has been illustrated and described in detail in the foregoing drawings and description, the same is to be considered as illustrative and not restrictive in character, it being understood that the only illustrative embodiments thereof have not been shown and described and that all changes and modifications that come within the spirit of the invention are desired to be protected.

What is claimed is:

1. A panel for a storage container comprising:
a first, generally planar layer, and
a second layer coupled to the first layer, wherein the second layer is configured to define a plurality of channels therein.

2. The panel of claim 1, wherein the plurality of channels includes a plurality of inner channels between the first layer and the second layer and a plurality of outer channels.

3. The panel of claim 1, wherein a cross-sectional shape of the channels is generally semi-circular, rectangular, triangular, and/or trapezoidal.

4. The panel of claim 1, wherein the channels are interlocking and/or overlapping embossments.

5. The panel of claim 4, wherein the channels are cross-shaped embossments.

6. The panel of claim 1, wherein the first and second layers are made from metal.

7. The panel of claim 1, wherein the channels are configured to extend along a width of the panel.

8. The panel of claim 1, wherein the first and second layers are coupled to each other by an adhesive, friction welding, and/or resistance welding.

9. The panel of claim 1, further comprising a third, generally planar layer coupled to the second layer and spaced-apart from the first layer.

10. The panel of claim 1, wherein the first layer is made of a first material and the second layer is made of a second material different from the first material.

11. The panel of claim 10, wherein the first material is steel and the second material is aluminum.

12. A panel for a storage container comprising:
a first, generally planar layer, and
a second layer coupled to the first layer, wherein the second layer is configured to define a first portion adjacent and coupled to the first layer, and a plurality of second portions spaced-apart from the first layer.

13. The panel of claim 12, wherein the second portions are configured to define a generally cross-shaped void between the first layer and the second layer.

14. The panel of claim 12, wherein the first portions are generally planar.

15. The panel of claim 14, wherein a cross-sectional shape of the second portions is generally semi-circular, rectangular, triangular, and/or trapezoidal.

16. The panel of claim 12, wherein the panel is a sidewall panel of the storage container.

17. The panel of claim 12, wherein the panel is a roof panel of the storage container.

18. The panel of claim 12, further comprising a third, generally planar layer coupled to the plurality of second portions of the second layer.

19. The panel of claim 12, wherein the first layer is configured to be an outer layer and the second layer is configured to be an inner layer of the storage container.

20. A sidewall panel for a storage container comprising:
an outer, generally planar metal sheet, and
an inner metal sheet coupled to the outer sheet,
wherein a plurality of channels are formed between the inner sheet and the outer sheet,
wherein the plurality of channels are configured to extend along a width of the panel to define a longitudinal axis parallel to a length of the storage container.
